(19) United States
(12) Patent Application Publication
(10) Pub. No.: US 2020/0218946 A1
(43) Pub. Date: Jul. 9, 2020

(54) Methods, architecture, and apparatus for implementing machine intelligence which appropriately integrates context

(71) Applicant: Luca Dell'Anna, Torino (IT)

(72) Inventor: Luca Dell'Anna, Torino (IT)

(21) Appl. No.: 16/732,348

(22) Filed: Jan. 2, 2020

Related U.S. Application Data
(60) Provisional application No. 62/788,105, filed on Jan. 3, 2019.

(51) Int. Cl. G06K 9/62; G06F 17/16

(52) U.S. Cl. CPC G06K 9/6289; G06K 9/6259; G06K 9/6261; G06F 17/16

(57) ABSTRACT

A method to process data. A plurality of data points or a representation of a plurality of data points is created combining the data traversing processing units of the system with other data accessible to the system (including data from its memories, interfaces and processing units), and an operation of compression or of pattern recognition is applied to the output of the previous operation.

### CROSS-REFERENCE TO RELATED APPLICATIONS

This non-provisional patent is related to provisional patent with EFS ID 34756802, application Ser. No. 62/788,105, “Methods, architecture, and apparatus for implementing machine intelligence which appropriately integrates context”, filed on the 3^{rd} of Jan. 2019.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

### Field of the Invention

The present invention relates to the field of memory systems, digital filters and machine intelligence. In particular the present invention discloses methods, apparatuses, and architecture for implementing systems able to efficiently compress incoming data and/or make sense of it and/or represent them in a way that makes it easier to act upon it.

### Description of Related Art

The field of Artificial Intelligence (AI) mostly produced so far programs and machines which have been able to exhibit limited learning capacities, for examples in fields such as image recognition, or which exceeded human intelligence, however only in restricted fields such as chess playing. AI systems still struggle in fields where context influences the interpretation or the meaning of the information it receives as input.

Specifically, current AI systems are unable to reliably consider context when relevant and to neglect it when irrelevant. In other words, they are not able to accurately separate context into relevant and irrelevant bits. In contrast, humans are proficient in determining, on the spot and in situations novel to them, which part of context is relevant and which isn't.

Humans use context to infer meaning. An AI which is unable to appropriately use context is impaired in mastering fields in which context is relevant. In order for an AI to achieve general intelligence, it needs to be able to understand by itself whether a piece of contextual information is relevant and how to use it. Such skill would allow the AI to infer the meaning of the objects it is observing from their context, and therefore to take better decisions.

A further application of an AI able to differentiate relevant from irrelevant context is data compression. If an AI is able to recognize which parts of a piece of information is irrelevant, then it can neglect it and focus on storing only the data which is relevant or meaningful. This allows for more efficient storage and processing of data.

Hierarchical Temporal Memory (HTM) is an AI framework which takes inspiration from the microscopic architecture of the human brain to produce systems able to perform pattern recognition. The preferred embodiment for the invention builds upon one of such system called “spatial pooler”, but other embodiments might be produced which do not rely on HTM systems.

### BRIEF SUMMARY OF THE INVENTION

The following invention allows for the creation of a machine exhibiting some traits of machine intelligence, in particular the ability to distinguish relevant from irrelevant context and to appropriately integrate it into the perception of incoming data. This causes the machine to generate meaningful representations of the data observed.

Such a machine has many advantages, including producing better decisions when context is relevant, compressing information more efficiently while preserving meaning, and allowing meaning to emerge by integrating relevant contextual information.

Some embodiments comprise one or more processing units which apply a contextualization operation followed by a pattern recognition operation, in order to integrate the context which is confirmed as relevant and to neglect that which resulted irrelevant (where relevancy is proxied by predictive value, i.e. contribution to patterns). A contextualization operation consists in producing an output which is a plurality of information points, each combining a single data point or a pattern of data points from each of two or more incoming sets of data (in some embodiments, at least some of which represent the “content” and at least some of which represent the “context”; the output represents a set of “contextualized content points” in which the following pattern recognition operation will weed out the irrelevant ones—those which did not contribute to any pattern). In some embodiments, the operations of contextualization and pattern recognition are applied multiple times in alternation, to produce better results.

### BRIEF DESCRIPTION OF THE SEVERAL VIEWS OF THE DRAWING

FIG. 1 shows a simplified non-comprehensive framework for feedforward information flows in the human (neo)cortex.

FIG. 2 shows a simplified non-comprehensive diagram of the architecture of the preferred embodiment and of its feedforward information flows.

FIG. 3 shows a simplified non-comprehensive diagram of how a processing unit of the preferred embodiment works.

FIG. 4 shows the main steps for the operation of contextualization as performed by a processing unit of the preferred embodiment.

### DETAILED DESCRIPTION OF THE INVENTION

### Summary of the Preferred Embodiment

Theory of operation of the human neocortex.

The human neocortex is made of millions of neurons which are loosely organized in regions. Information enters the human brain as sensory data and traverses a multitude of regions. Each region refines the information that passes through it, removing meaningless information and adding context, producing more stable and more meaningful representations.

Each region receives information from two sets of sources, which are here called “content” and “context”. The information that is the object of the region's processing constitutes the content, whereas context is the information used to help processing content. For example, a region charged with recognizing written words could use the visual data of how a word is scribbled on a document as the content to process, and previously known information about the topic of the document as context. As another example, a region charged with recognizing faces might use visual information such as the shape of the chin and of the noise of a man as content, and information about his silhouette and his tone of voice as context.

It is widely believed that regions in the human neocortex are organized following some kind of loose hierarchy. In such framework, the output of the regions hierarchically below a given one would be its content, whereas the output of some or all the other regions sending information to it would be its context.

Context can also include the information processed by the same region a few instants before, for example when processing the previous words scribbled on the document or the previous notes in a melody. This is called “temporal context”.

Each region of the human neocortex performs at least two operations which are fundamental to the interpretation of incoming sensory data: “pattern recognition” and “contextualization”. During the former, the regions recognize patterns in content data and categorize them as “features”. During the latter operation, features get paired with patterns recognized in the context in order to create data elements called “contextualized features”.

Contextualized features are tentative: they might represent signal (if they have predictive value) or they might represent noise (if they are the result of a random coincidence). The job of the next region through which the information will pass is to determine which contextualized features have predictive value (and to neglect those which do not). The next region does so by applying the operation of pattern recognition: those contextualized features which form recurring patterns or contribute substantially to them will be recognized as signal and further processed, whereas those which do not will be disregarded as noise.

In the human neocortex, the operation of pattern recognition is performed by cortical columns operating as units, whereas the operation of contextualization is performed by the neurons inside those columns. (Cortical columns are structures composed of a few dozen neurons.)

The framework described above, while having strong bases in biological and neurological studies, conceptually differs from most widely known theories in a few ways. In particular, it holds that the functional unit in the human neocortex is not a region performing the operations of pattern recognition and contextualization in that order; but the part of one or more regions performing contextualization together with the part of the next region in the hierarchy performing pattern recognition. Such distinction is clarified in FIG. 1.

In FIG. 1, the union of elements 101 and 102 represents a single cortical region. The unions of elements 103 and 104, of elements 105 and 106, and of elements 107 and 108 are also cortical regions. Element 109 represents the other parts of the nervous system which transmit sensory stimuli to the cortex. Elements 102, 104, 106 and 108 perform the pattern recognition operation on the input to the cortical region they belong to. Elements 101, 103, 105 and 107 perform an operation of contextualization on the output of elements 102, 104, 106 and 108 respectively. Elements 102, 103, 105 and 107 as a whole represent a functional unit of the human cortex. Each time a stimulus passes through such a functional unit, the operation of contextualization performed by elements 103, 105 and 107 integrates context into the stimuli and the operation of pattern recognition performed by element 102 ensures that of the context integrated during the previous step only the relevant bits are retained and transmitted to element 101.

### Brief Description of the Preferred Embodiment

The present invention proposes a method for processing a stream of data. Using this invention is likely to result in any of the following benefits: integration of the relevant context, exclusion of irrelevant information (achieving compression), and the surfacing of meaningful information. Such method consists into the application of at least two operations: first, one called “contextualization” and second, one called “pattern recognition”. For better effects, such operations can be applied in alternance to the data entering the system more than once, each time by one or more processing units organized in a hierarchy, preferably a converging one. In case a hierarchy of processing units is used, sensory data (the stream of data entering the hierarchy from its bottom) loosely climbs the hierarchy.

The operation called contextualization takes two inputs: “content data”, which is a snapshot of the stream of data being currently examined by the processing unit, and “context data”, which is a snapshot of the representation of the whole stream of data currently being examined by the system in general and of the content of any short-term memory units the system might have. In the example of an image recognition software, “content data” would be the visual representation of the scribbled word currently examined by the processing unit, whereas “context data” would be the visual representation of the whole sheet of paper plus the previous output of the region itself plus all other data stored by the machine and pertaining to the sheet at hand or its context (e.g., its metadata, its topic, etc.).

Both content data and context data contain a plurality of data elements (each of which is a data point or an ensemble of data points). Such data elements might be bits. The output of contextualization is a plurality of data elements, representing all the possible combinations of one or more active content element with one or more active context element. The abstract meaning of each output data element is a “contextualized content pattern” data element which represents the presence of a “contextualized feature” in the space described by the data stream comes from. The output of the operation of contextualization is thus a plurality of contextualized features.

It has to be noted that the output of the operation of contextualization often contains many contextualized features, some of which are relevant and some of which are not. Some might even be errors or illusions. The operation of contextualization alone is usually not enough to weed out irrelevant contextualized features from relevant ones, right ones from wrong ones. At some point after the operation of contextualization, an operation of pattern recognition (described later) has to be applied, with the result of only keeping those contextualized features which are recognized as similar enough to already-sensed patterns and of abandoning those who do not. This is advantageous, as in general the former are relevant and truthful while the latter are irrelevant or mistaken ones, and carrying forward only the former allows to compress the information and to let signal emerge from the noise, surfacing meaning.

In some cases, a single operation of contextualization followed by a single operation of pattern recognition is not enough to weed out random or spurious patterns of contextualized features. The repeated application of contextualizations and pattern recognitions takes care of it. In this case, due to the loosely converging hierarchy of the system, subsequent operations of contextualizations and pattern recognition are applied to progressively broader data—allowing for progressively broader and more abstract meaning to emerge.

The operation called pattern recognition takes as its input part or all of the output of one or more contextualization operations (from the processing units hierarchically below it) and produces an output which represents the pattern(s) recognized in the input. For best results, the processing unit performing pattern recognition should be able to dynamically learn patterns in its inputs.

Often, the operation of pattern recognition results in a compression of the data subject to it. On the other hand, many compression algorithms use some form of pattern recognition. Therefore, some embodiments can use a compression algorithm to perform the operation of pattern recognition.

The result of the sequential application of contextualization and pattern recognition is that only the patterns of content—context associations that are stable over time (i.e., those that provide predictive information) get retained, whereas the others get filtered out. This happens because contextualization proposes each possible context for each possible feature; then, pattern recognition only takes into account those that form patterns and removes those that represent noise.

The operation of pattern recognition is often applied at a higher level of the hierarchy than the last operations of contextualization applied to its inputs (for example, in FIG. 1, element 102 performs the pattern recognition on the output of 103, 104 and 105, which are all at a level below it). This means that the scope of subsequent operations of pattern recognition tends to be progressively larger. Moreover, each contextualization followed by a pattern recognition results in some details of the content being compressed and some of the context being integrated. Consequently, as the data progresses upwards the hierarchy, it tends to contain less details and more context: more meaning. For example, while reading a book, the information from the book enters the brain mostly as visual information of how the ink is distributed on the page. The first brain regions the data traverse tend to express visual content (lines); then, as it progresses upwards in the hierarchy, lines become letters, letters become words, words become sentences, and sentences become concepts. At the beginning, it was all about visual details; at the end, the details are gone and only the meaning is retained.

The progressive integration of context into (sensory) content is what possibly leads to the emergence of meaning in the human neocortex, or at least contributes to it.

### Detailed Description of the Preferred Embodiment

Methods, architecture, and apparatus for implementing machine intelligence are disclosed. In the following description, to facilitate explanation, specific nomenclature is used to provide a good understanding of the present invention. However, it will be clear to one skilled in the art that these specific details are not required in order to practice the present invention. For example, the present invention has been described in an embodiment apt to be used in a larger machine learning system using sparse distributed representations to represent part of the data. However, other types of systems may be used. The numerous teachings of the present invention are set forth with reference to a simple handwriting recognition system that uses image information as sensory input. However, the principles of the present invention can be applied to any type of environment with any type of input.

This invention contains concepts from the field of computer science. Therefore, the term “or” will often be used with its technical definition of an operator which returns a true value when one or both operators are true, as distinguished from the “and” operator which returns a true value only when both operators are true.

Architecture of the System

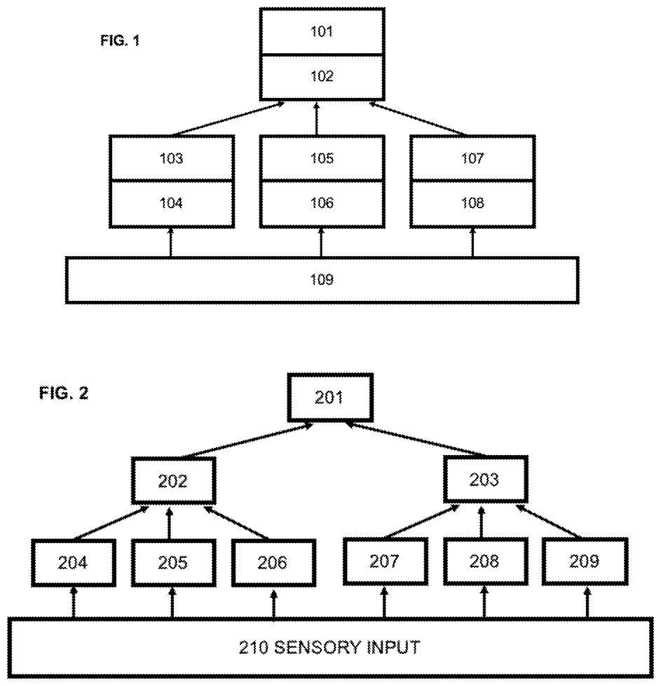

The preferred embodiment is a system containing a set of processing units (PUs) loosely organized in a converging hierarchy. The output of each PU is passed as “content data” to the PU immediately above it in the hierarchy, for further processing. The PUs at the lowest level of the hierarchy receive input data from outside the system (“sensory data”). Such sensory data might be generated by physical sensors or by communication interfaces with other systems; for example, it might be the output of a camera taking a picture of a sheet of paper where some words have been written. FIG. 2 depicts a partial and simplified example of the hierarchy described above. Some embodiments might be more complex, with a hierarchy having tens of levels and hundreds or thousands of PUs.

In FIG. 2, elements 201 to 209 represent PUs. Elements 204 to 209 form the lowest level and receive input from element 210, which represents all inputs from sensors or external data.

The hierarchy can be loose and does not have to converge. For example, in some embodiments there could be just as many PUs in the topmost level as in the lowest one. As another example, in some embodiments the hierarchy might consist of a single PU per level. As a further example, a PU at a given level can connect to multiple PUs at the level above. As another example, other embodiments might have multiple elements providing sensory data or constituting an interface to the outer world. In such case, any PU receiving input from them could be considered “at the lowest level”. Moreover, the output of a PU can be sent as content data to another PU a few levels above or below. However, in general, in the preferred embodiment, sensory data passed as content data is expected to mostly climb the hierarchy in a convergent form.

In FIG. 2, for example, the output of elements 204, 205 and 206 forms the content data for element 202. In another embodiment, a few links across levels of the hierarchy could have been formed. For example, element 207 could have been linked directly to element 201, so that the output of the former could serve as a source of content data for the latter.

In the case that at a given level some PUs share the same source for content data (as in the case of the lowest level), then each PU has to be given access to a different subset of the output data of such sources, so that they will each receive different content data and will therefore produce a different output. Such subsets might overlap.

Each PU is tasked with processing the content data it receives. In order to do so, the PU uses a different kind of data called “context data”. Such data comprises of part of all of the output of some or all of the other PUs and memory units in the system. Contextual data might include any current or recent output of the other PUs in the system (in which case their output is used both as content data for the PUs they are connected to in the hierarchy described in this section and as context data for some or all of the PUs in the system). Contextual data might also include a representation of the past output of the PU itself (“temporal context”). In the example of the preferred embodiment which is used to analyze a sheet of paper to make sense of any words written on it, context data might represent both the topic of the writings (as inferred by the previous words or sheets examined), the context in which the sheet has been found (for example, on a kitchen table), or the image of the next word to analyze. In the example of FIG. 2, element 202 processes the output of 204, 205 and 206 as content data and the output of all the other PUs as context data. PU 204 receives content data from 210 and context data from all the other PUs.

In the preferred embodiment, a PU only uses as contextual data the output of the PUs at the same level of the hierarchy or at one above it and its own output at the previous time step. Other embodiments might use a more inclusive subset of PUs of the system as providers of contextual data, or a smaller subset, as it best fits the case. Some embodiments might even use some form of machine learning to determine the subset of PUs, memories and sensors to use as providers of contextual data.

Representation of Information

The PUs of the preferred embodiment relay on data being encoded with a stable number of bits every time it enters the PU. Different PUs in the system might each use a different number of bits to encode their input, but for a given PU that number should remain constant or can change very slowly compared to the rate of change of the content of the data itself (usually, at least orders of magnitude slower). Faster rates of change might compromise the ability to create stable representations of patterns.

To guarantee this requirement for the input of the PUs receiving sensory data, the apparatuses providing such data could be chosen or configured in such a way that either their output is produced in packets of a constant size or that their output is on a parallel channel with constant bandwidth.

Architecture of the Processing Units (PUs)

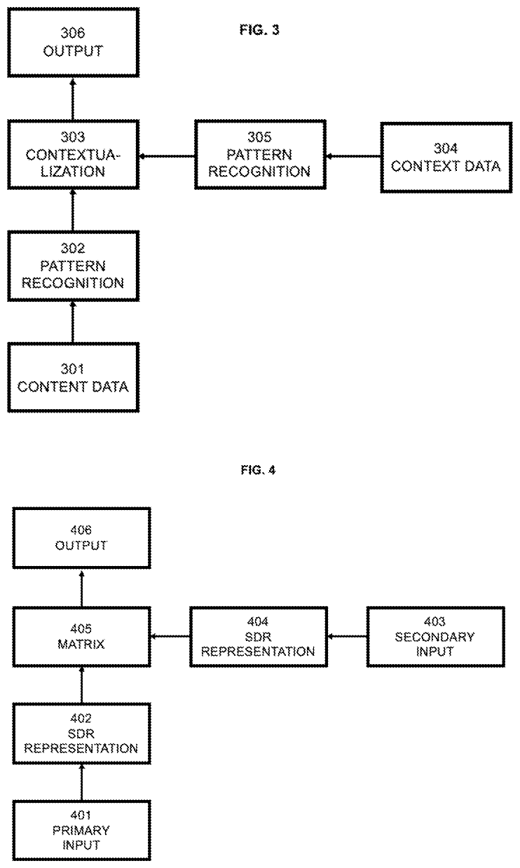

In the preferred embodiment, each PU performs two operations. First, it performs an operation hereafter called “pattern recognition”, using content data as its input. Second, it performs an operation hereafter called “contextualization”, using as its inputs the output of pattern recognition and contextual data. An optional operation of pattern recognition might be applied to context data before it is used as an input for the operation of contextualization. The output of the PU is the output of the operation of contextualization. This sequence of operations is depicted in FIG. 3.

It has to be noted that subjectively to PUs, pattern recognition takes place before contextualization; however, functionally, data is processed by an operation of contextualization followed by an operation of pattern recognition. This apparent inconsistency is resolved by the fact that the output of a PU becomes the input of another, and therefore, in practice, information is generally applied many times over both operations in alternation (so that which one comes first matters less).

In FIG. 3, a primary input enters the PU as content data, represented by element 301. The PU applies an operation of pattern recognition to the content data; the output of such operation, represented by element 302, will be used as the primary input for contextualization. Moreover, the PU receives data from other PUs in the system; such data enters the PU itself as context data, represented by element 304. The PU applies an operation of pattern recognition to the context data; the output of such operation, represented by element 305, will be used as the secondary input for contextualization. Finally, the PU applies an operation of contextualization, represented by element 303. Its output will form the output of the PU and will be transmitted to other PUs in the system.

Pattern Recognition

In order to perform the operation of pattern recognition, in the preferred embodiment, each PU comprises of a set of units called “categories”. Each category comprises of a set of “synapses”. Each synapse contains a reference to a given bit of the content data which is the input of the PU and a permanence value which is a decimal between 0 and 1. In the preferred embodiment, each PU contains 1000 categories and each category contains about 100 synapses, though other embodiments might use different quantities. It is desired that the number of synapses is much larger than the number of bits representing the content data.

When the system is created, each synapse is initiated by giving it a reference to a random bit of the content data and a permanence value randomly chosen in the proximity of 0.7. Moreover, each category is assigned a “boost” value of 0. It is possible (and desired) that each content data bit is referenced by multiple synapses, each pertaining to a different category.

At each time step the PU performs the following steps. First, it activates those synapses whose connected bit in the content data is 1 and whose permanence value is equal to or greater than 0.7. Second, it calculates a score for each category, which is equal to the percentage of active synapses multiplied by 1 plus its boost value if such percentage is higher than 75% or 0 otherwise. Third, it ranks the categories in descending order of score. Fourth, it selects the top category and removes from the ranking those categories for which at least 60% of their synapses have their reference contained in the set of references of all the synapses of the selected category. Fifth, the fourth step is repeated with the unselected categories remaining in the ranking, one at a time proceeding in descending order, until at least 2% of the categories have been selected or until the ranking has been exhausted, whichever comes first. Sixth, an output is produced wherein each of its bits represents a given category and whose value is 0 if the category is inactive and 1 if the category is active. It is necessary that the order of categories referenced by the output bits does not change over time (or changes extremely slowly). For example, the third bit of the output should always represent the same category, regardless of its score or of its order in the ranking. Seventh, for each category, its boost value is increased by 0.08 if it is inactive or is set to 0 if it is active. Eight, for each active category, the permanence of the synapses whose reference bit was active is increased by 0.1, and the permanence of the others is decreased by 0.1. If the permanence value of any synapses is negative, it is set to 0, and if it is greater than 1, it is set to 1.

The fourth and fifth step are necessary to ensure that categories represent different information from each other, and to allow for some capacity of adaptation mimicking neuroplasticity in the human brain. The seventh and the eight step above are necessary to ensure that the PU is able to learn those patterns that keep reproducing in its input.

The coefficients of 0.7, 75%, 60%, 2%, 0.08 and 0.1 above have been chosen for the preferred embodiment as generally effective, but other embodiments might use different coefficients. Some embodiments might even use some form of machine learning to use adaptive coefficients.

A practitioner skilled in the art and familiar with Hierarchical Temporal Memory theory will recognize that the apparatus that such theory calls a spatial pooler is an apparatus apt to perform the operation of pattern recognition. However, embodiments might use other suitable apparatuses or machine learning techniques to perform the operation of pattern recognition.

Contextualization

The output of the pattern recognition operation expresses the recurring patterns or “features” recognized in the content data. Such output (hereafter “feature data”) is the primary input for the next operation, contextualization.

The secondary input of contextualization is the context data received by the PU. In the preferred embodiment, an operation of pattern recognition is applied to context data and its output is used as the secondary input of contextualization. Other embodiments might instead not apply the operation of pattern recognition to context data (and only apply it to content data, which serves as the primary input).

The purpose of contextualization is to create a representation whose data points are the result of associations between the components of its primary input and its secondary input.

Contextualization receives two inputs: primary and secondary. In the preferred embodiment, each input is encoded as a horizontal vector which is a fixed-length array of bits. The length of the primary input vector can be different from that of the secondary input one (or can vary across different PUs; however, given a PU and a type of input, its length is fixed or at least changes slowly and progressively, at least several orders of magnitude more slowly than its content). In the preferred embodiment, contextualization takes place by transposing the secondary input vector (so that it becomes vertical) and by multiplying it with the primary vector in order to form a matrix. In other words, each cell of the matrix represents a couple (primary input bit, secondary input bit) and it contains a 1 if and only if both components of the couple are a 1. For example, cell (x, y) of the matrix will be a 1 if and only if the x-th bit of the primary input vector and the y-th bit of the secondary input vector are both 1. The output of contextualization is a horizontal array formed by the concatenation of the rows of the matrix.

FIG. 4 describes how contextualization is realized in the preferred embodiment. The primary input, depicted by element 401, is represented using a vector of zeros and ones, depicted by element 402. The secondary input, depicted by element 403, is represented using a vector of zeros and ones, depicted by element 404. The secondary input vector is transposed and then the two vectors are then multiplied in order to form a matrix, represented by element 405. The output, represented by element 406, is a vector which is the concatenation of the rows of the matrix. Such vector can be considered a sparse distributed representation of the concept or concepts tentatively recognized by the PU.

The output the PU is the output of the contextualization operation. Such output is not very meaningful by itself, as some of its bits will be the expression of signal while other will be the expression of noise. However, PUs are often concatenated to each other, and the pattern recognition operation of one PU applied to the output of the contextualization operation of the PUs that connect to it will take care of removing such noise and ensure that what is passed upwards the hierarchy of PUs is mostly signal.

Other embodiments might use a different process to perform the operation of contextualization. For example, they might perform association operations other than the matrixial multiplication described above.

### Using the Preferred Embodiment

The preferred embodiment can be connected to some sensor or other kind of interface to the world. Such interface should preferably be chosen or configured in such a way that either its output is produced in packets of a constant size or that its output is on a parallel channel with constant bandwidth, so that sparse distributed representations can be used.

Once the preferred embodiment is connected to such interface and once such interface starts transmitting data, the embodiment begins to learn patterns in such data and generating more meaningful representations of it. Other AIs, Machine Learning systems, or computerized systems can be connected to the output of the some of the PUs high in the hierarchy: the data they will receive from them will be much more stable and more meaningful than that of the sensors, just like the output of the higher regions of the human brain is more stable than the output of the regions which directly receive sensory data. A much lower number of iterations of supervised learning (to couple the output of such PUs to the real-world object it corresponds) will be needed to train the resulting system in order to achieve artificial intelligence than the number of iterations that would be required by other current state-of-the-art machine learning systems (and, in some cases and contexts, no rounds of supervised learnings might be needed). Moreover, such system should be able to work much more effectively in situations where the importance or definition of context are unclear or varying.

Other embodiments might be connected to interfaces in other ways, and their output might be consumed by other systems in different ways. For example, the output of the highest PUs in the hierarchy might be used as an input to motor systems (to create a machine with some action or decision making capabilities) and in particular as an input to motor systems governing sensors or connected to them (to create a machine with the capability of influencing the collection of data in order to further disambiguate its inputs or to fulfill other needs of its).

1. A method to process data, comprising the steps of:
a. obtaining a plurality of data points or a representation of a plurality of data points, each representing the association between a subset of the data to process and a subset of the data accessible to the system (including the data stored in its memories and the data streams entering the system).
b. applying an operation of compression or pattern recognition to the output of step a or to part of it.

2. The method of claim 1, in which the inputs to some or all of steps a and b are represented using a sparse distributed representation.

3. The method of claim 1, further comprising multiple iterations of step a and b, where each subsequent iteration is applied to the output of any of the previous iterations, so that data entering the system undergoes a series of applications of the method of claim 1.

4. The method of claim 3, in which data exiting some or any of its steps is represented using sparse distributed representations.

5. The method of claim 1, in which the operation of step a is produced multiplying two vectors.

6. The method of claim 5, in which data exiting some or any of its steps is represented using sparse distributed representations.

7. The method of claim 1, in which the operation of step a is performed with an association rule or association function which dictates which bits of a result array are true based on the values of some bits in at least two input vectors.

8. The method of claim 7, in which data exiting some or any of its steps is represented using sparse distributed representations.

9. A system to process data, comprising of one or more nodes, at least some of which perform an operation of compression or pattern recognition on the data entering them and at least some of which perform an operation whose output data represents a plurality of associations between elements of the data coming from connected nodes and elements of the data accessible to the system (including the data contained in any other node, the data being stored in any memory unit of the system, and the data entering the system).

10. A system to process data, comprising of one or more nodes organized in a network, at least some of which perform a sequence of operations comprising:
a. creating a plurality of data points, each symbolizing or being the result of an association between one or more bits or data points entering the node from a subset of the nodes connected to it and one or more bits of data points available to the system (without the restriction of coming from the first subset of nodes).
b. some form of compression, pattern recognition or both, applied to the output of step a or to parts of it.

11. The system of claim 10, in which spatial poolers are used to perform step b.

12. The system of claim 10, in which the input of any nodes is represented using a sparse distributed representation.

13. The system of claim 10, in which some nodes contains a processing unit or function being able to transform incoming data into one or more sparse distributed representations.

14. The system of claim 10, in which at least some of the input to its nodes represents the output of sensors.
